(19) United States
(12) Patent Application Publication
(10) Pub. No.: US 2007/0002851 A1
(43) Pub. Date: Jan. 4, 2007

(54) Transmission and reception of session packets

(76) Inventors: Toni Paila, Degerby (FI); Topi Pohjolainen, Helsinki (FI)

Correspondence Address: MORGAN & FINNEGAN, LLP, 3 World Financial Center, New York, NY, 10281-2101, US

(21) Appl. No.: 11/169,586

(22) Filed: Jun. 30, 2005

(51) Int. Cl. H04L 12/56

(52) U.S. Cl. 370/389

(57) ABSTRACT

Techniques are provided that indicate the termination of a session. For instance, a final data packet of a transport session (e.g., an ALC session) is transmitted across a transmission medium within a time period. Also within this time period, an end of session (EOS) packet corresponding to the transport session is transmitted across the transmission medium. In addition, a further EOS packet corresponding to the transport session may be transmitted within a subsequent time period. The transmission medium may be a broadcast medium. Examples of such broadcast networks include DVB-H, DVB-T, and cable networks. Accordingly, the time periods may be time slices.

### FIELD OF THE INVENTION

The present invention relates to communications. More particularly, the present invention relates to the delivery of session packets.

### BACKGROUND OF THE INVENTION

Delivering multimedia content, such as audio and/or video, to terminal devices in digital format is becoming increasingly commonplace. Accordingly, various protocols and encoding techniques have been developed to provide such content in the form of packet-based sessions.

Such content may be delivered over various broadcast transmission media. One such broadcast transmission medium is provided by digital video broadcast handheld (DVB-H). DVB-H provides a total capacity that is divided into a number of timeslice channels, each having a static bit rate to facilitate mobility and handover. For mobile and indoor reception, a DVB-H channel's capacity is typically between 5 and 15 megabits per second (Mbps). For a particular multimedia stream, a certain amount of bandwidth is typically allocated to the corresponding broadcast channel (e.g., to the corresponding DVB-H timeslice). Ideally (but not necessary), a DVB-H timeslice channel contains only a single multimedia stream to lower power consumption in terminal devices.

The nature of various media, such as DVB-H channels, may cause the occasional loss of transmissions. In certain cases, receiving devices may fail to receive transmissions indicating that a session is finished. Accordingly, it is desirable to provide reliable and robust techniques that indicate session termination.

### SUMMARY OF THE INVENTION

The present invention provides techniques that indicate the termination of a session. For instance, the present invention provides a method in which a final data packet of a transport session (e.g., an ALC session) is transmitted across a transmission medium within a time period. Also within this time period, an end of session (EOS) packet corresponding to the transport session is transmitted across the transmission medium. In addition, the method may transmit a further EOS packet corresponding to the transport session within a subsequent time period.

In embodiments, the transmission medium is a broadcast medium, and the time period is a first time slice and the subsequent time period is a second time slice occurring after the first time slice. Examples of such broadcast networks include DVB-H, DVB-T, and cable networks. The EOS packets may each include an end of session indicator. Further, the EOS packets may each include a session identifier identifying the transport session.

An apparatus of the present invention includes a controller and a transmission module. The controller establishes a transport session, and the transmission module sends data packets of the transport session to one or more devices. In addition, the transmission module transmits a final data packet of the transport session within a time period. Moreover, the transmission module transmits an EOS packet corresponding to the transport session within the time period. The transmission module may also transmit a further EOS packet corresponding to the transport session within a subsequent time period.

In addition, the present invention also provides computer program product aspects.

Aspects of the present invention increase the reliability in which session terminations are indicated. Further features and advantages of the present invention will become apparent from the following description and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an operational environment according to embodiments of the present invention;

FIG. 2 is a diagram of an Asynchronous Layered Coding (ALC) packet format;

FIG. 3 is a detailed exemplary diagram of an Asynchronous Layered Coding (ALC) packet format;

FIG. 4 is a diagram of an environment involving various broadcast/multicast networks;

FIG. 5 is a diagram showing an exemplary packet transmission sequence;

FIG. 6 is a diagram of a session provider apparatus; and

FIG. 7 is a diagram of a computer system.

### DETAILED DESCRIPTION OF THE PREFERRED EMBODIMENTS

I. OPERATIONAL ENVIRONMENT

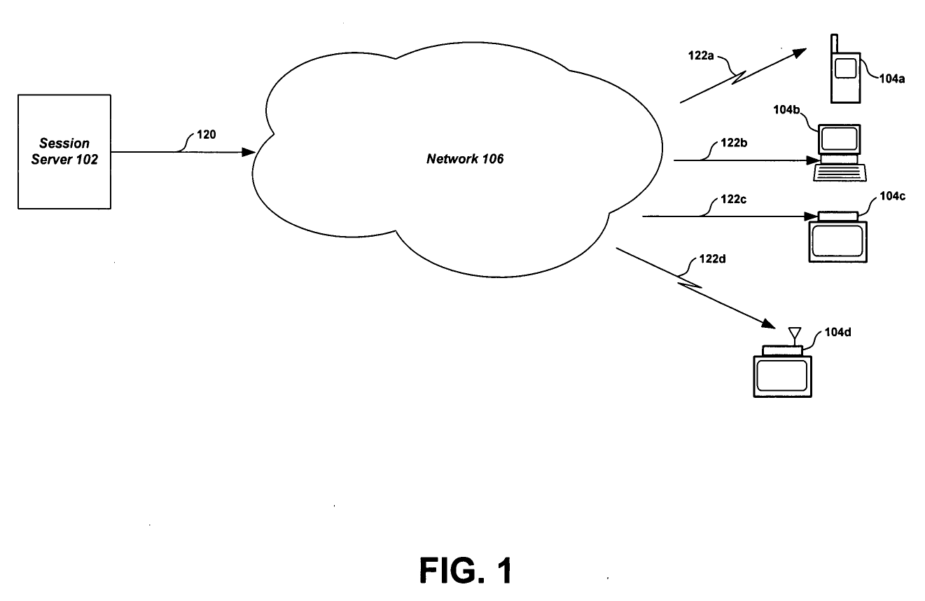

FIG. 1 is a diagram of an exemplary operational environment in which the present invention may be employed. This environment includes a server 102 and a plurality of receiving devices 104. As shown in FIG. 1, these devices are connected by a network 106. In embodiments of the present invention, server 102 employs a transport session 120 to provide devices 104 with content 122 (e.g., files, video, audio, multimedia, etc). This session may involve the use of one or more protocols, such as the Asynchronous Layered Coding (ALC) protocol, the user datagram protocol (UDP), and the Internet protocol.

Network 106 provides for end-to-end delivery of content from server 102 to devices 104. To provide for this delivery, network 106 may actually be composed of multiple networks, such as the Internet and one or more broadcast networks.

Devices 104 may be of various types. For example, FIG. 1 shows that device 104a is a portable wireless communications device, such as a mobile phone or a personal digital assistant (PDA). Device 104a is configured to receive signals from a short-range or longer range wireless system. Examples of such systems include Bluetooth networks, wireless local area networks (WLANs), wireless personal area networks (WPANs), cellular networks, digital broadband broadcast networks, and satellite communications systems. Device 104b is a personal computer that receives content from the Internet. In contrast, devices 104c and 104d are televisions equipped to receive broadcasts from cable and wireless transmissions, respectively.

An example of a digital broadcast standard and method that may be employed by such digital broadband broadcast networks includes Digital Video Broadcast—Handheld (DVB-H). Further examples of standards and methods include Digital Video Broadcast—Terrestrial (DVB-T), Digital Video Broadcast—Satellite (DVB-S), Integrated Services Digital Broadcasting—Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Forward Link Only (FLO), Digital Audio Broadcasting (DAB), and Digital Radio Mondiale (DRM). Other digital broadcasting standards and techniques, now known or later developed, may also be used.

II. ALC

As described above, embodiments of the present invention may employ various transport protocols. One such protocol is Asynchronous Layered Coding (ALC). ALC is an error-resilient multicast transport protocol that provides reliability through the use of forward error correction (FEC). ALC, which employs the user datagram protocol (UDP) and the Internet protocol (IP) protocol, may be used in various types of wireless multiple-access networks such as UMTS, WLAN, DVB-H, DVB-T and DVB-S.

ALC is a protocol described in M. Luby et al., “Asynchronous Layered Coding (ALC) Protocol Instantiation,” RFC 3450, The Internet Society, December 2002 (“RFC 3450”). This document is incorporated herein by reference in its entirety and may be downloaded from http://www.ietf.org/rfc/rfc3450.txt.

ALC provides congestion controlled reliable asynchronous delivery of content to an unlimited number of concurrent receivers from a single sender. This is performed by utilizing a Layered Coding Transport (LCT) building block, a multiple rate congestion control building block, and a Forward Error Correction (FEC) building block. ALC is designed to be used with the IP multicast network service and does not require feedback packets from receivers to the sender. Information, referred to as objects, are transferred from a sender to one or more receivers in an ALC session.

ALC can support several different reliable content delivery service models. One such model is called the push service model. This model involves the concurrent delivery of objects to a selected group of receivers. Another model is called the on-demand content delivery service model. In this model, a sender transmits an object (e.g., software) for a time period. During this time period, receivers may join the session and recover the object. This time period may be much longer in duration than the time required for a receiver to download the object. Thus, receivers join the session during such a time period and leave the session when they have received enough packets to recover the object. Such sessions are identified by a session description, which may be obtained, for example, through a web server. ALC uses a packet format that includes a UDP header followed by an LCT header, an FEC payload ID, and a packet payload.

LCT is described in Luby, et al., “Layered Coding Transport (LCT) Building Block”, RFC 3451, The Internet Society, December 2002. This document may be downloaded from http://www.ietf.org/rfc/rfc3451.txt. LCT provides transport level support for reliable content delivery and stream delivery protocols.

An LCT session includes one or more related LCT channels that originate at a single sender. The channels are used for a period of time to convey packets containing LCT headers. These packets may be received by one or more receivers. Although LCT requires a connection from a sender to receiver(s), it does not require a connection from the receiver(s) to the sender. Accordingly, LCT may be used for both unicast and multicast delivery.

An LCT header may include various flags. For instance, an LCT header may optionally include a Close Session flag. This flag indicates that the sender is about to stop sending packets to the session. Also, an LCT header may include a Close Object flag that indicates when the sender is about to stop sending packets to the session for the object identified by a particular Transmission Object ID. However, these flags are not considered a completely reliable mechanism. For instance, in certain transmission environments (such as radio broadcast links), errors occur. Therefore, receiving devices may miss a packet containing such flags. Accordingly, Section 1.1. of RFC 3450 indicates that (for a push delivery model) such flags should only be used as hints that a session is about to close or that transmission of packets for an object is about to end.

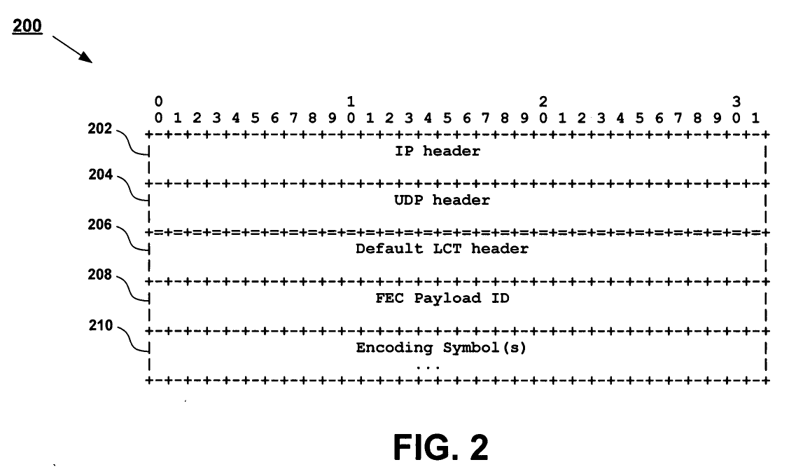

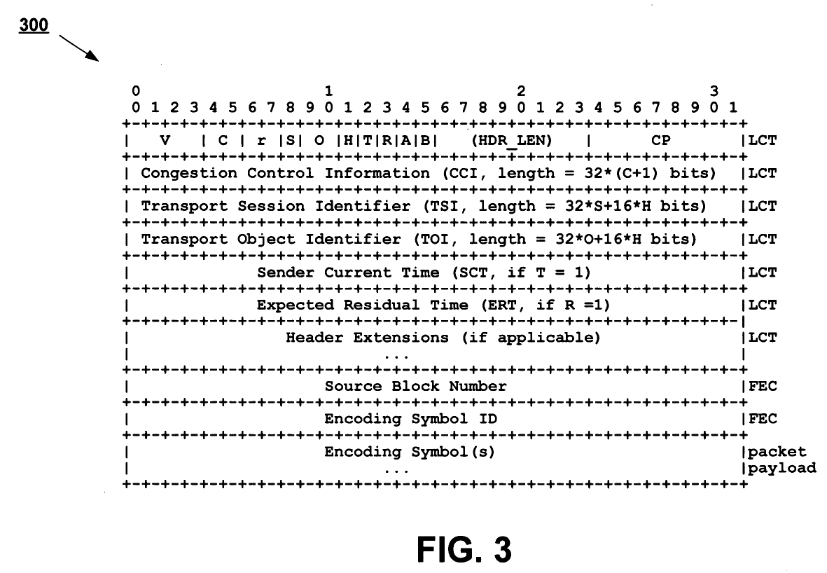

As described above, ALC uses a packet format that includes a UDP header followed by an LCT header, an FEC payload ID, and a packet payload. This arrangement is shown in FIGS. 2 and 3. In particular FIG. 2 is a diagram of an ALC packet format 200. This format includes an IP header 202, a UDP header 204, a default LCT header 206, an FEC payload ID 208, and encoding symbol(s) 210.

Packets according to format 200 are IP packets (either IPv4 or IPv6—the ALC packet format has no dependencies on the IP version number). For these packets, IP header 202 precedes UDP header 204. With respect to LCT header 206, RFC 3450 specifies that ALC packets require the default LCT header. This default header is described in detail in the LCT building block (RFC 3451).

FIG. 3 is a diagram of an exemplary ALC packet 300 starting with the LCT header (i.e., default LCT header 206). In this packet, the LCT header comprises the first six 32-bit words and possible header extensions. As shown in FIG. 3, the LCT header includes various fields. One such field is a Codepoint (CP) field. In this example, the Codepoint (CP) has the value 128. In addition, the LCT header includes a Transport Session Identifier (TSI) and a Transport Object Identifier (TOI). These fields are used to identify a particular session and particular object of the session. Also, the LCT header includes a Forward Error Correction (FEC) Payload ID, which includes of the next two 32-bit words Source Block Number (SBN), as required by the CP value 128. Moreover, the LCT header includes an Encoding Symbol ID (ESI). After this field, the remainder of the packet contains the payload.

Moreover, FIG. 3 shows that the LCT header includes various smaller fields. These fields include: an ALC version number (V), a Congestion control flag (C), a field that is reserved for future use (r), a Transport Session Identifier flag (S), a Transport Object Identifier flag (O), a Half-word flag (H), a Sender Current Time present flag (T), an Expected Residual Time present flag (R), a Close Session flag (A), and a Close Object flag (B).

III. END OF SESSION INDICATORS

In aspects of the present invention, more reliable end of session indications are provided by delivering a set of packets that indicate the end of a session. Such packets may be, for example, ALC packets with appropriate end of session flags. This transmission of multiple packets advantageously increases the probability that all receiving devices become aware of the session's termination. Upon receipt of a single end of session packet, a receiving device will “close” its session and cease to await further packets for the session. Thus, the receiving device may discard or ignore any subsequently received EOS packets.

According to one approach of the present invention, a set of packets carrying a Close Session flag, end of session packets (EOS packets), are transmitted within the same period of time (e.g., within the same burst) as the session's ending. For example, in certain broadcast networks, this period of time may be a time slice.

According to a further approach of the present invention, a set of EOS packets are transmitted during a period of time subsequent to the session's ending. For example, in certain broadcast networks, these periods of time may be two or more time slices.

In embodiments of the present invention, session packets carrying content payload (data) are precluded from having an end of session indicator (e.g., an ALC close session flag that is set). However, in alternate embodiments, a session packet may include both data and an end of session indicator.

Moreover, in embodiments, an EOS packet always includes session identifier that explicitly associates the packet with a specific session. For instance, in the context of ALC, a session's payload conveying packets and it's EOS packets may have the same transport session identifier (TSI).

Also, in certain network environments, packets may arrive out of order. However, in certain embodiments of the present invention, once a device receives an EOS packet, it will ignore them because the subsequent packets no longer have any semantics.

IV. OPERATIONAL ENVIRONMENT

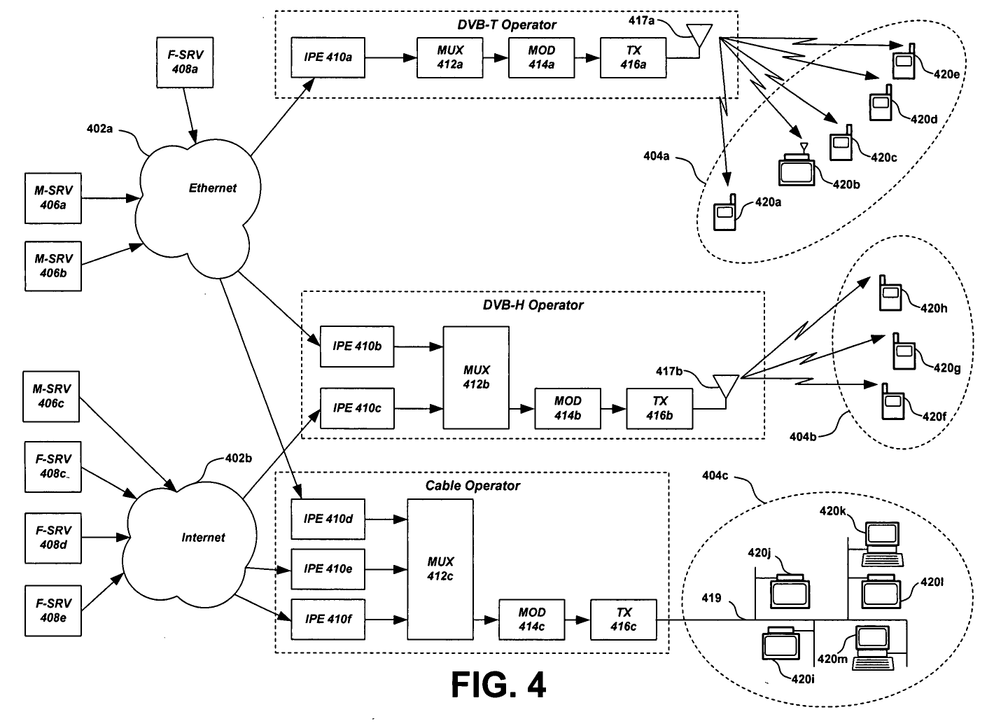

FIG. 4 is a diagram of a broadcast/multicast environment in which the present invention may be employed. This environment involves multiple packet-based networks 402 and multiple broadcast/multicast networks 404.

Networks 402 perform communications through the exchange of packets, such as Internet Protocol (IP) packets, through various protocols. Accordingly, networks 402 may be of various types. For instance, the environment shown in FIG. 4 includes a packet-based network 402a that is a local area network (such as an Ethernet), and a packet-based network 402b that is the Internet.

Networks 404 provide point-to-multipoint type communications over a broadcast transmission medium. Each of these networks may employ various wired or wireless technologies. For instance, FIG. 4 shows a DVB-T network 404a, and a DVB-H network 404b. In addition, FIG. 4 shows a cable network 404c, such as a Data Over Cable Service Interface Specification (DOCSIS) network. Networks 404a and 404b transmit wireless signals that may be received by devices within coverage areas.

The environment of FIG. 4 includes a plurality of multimedia streaming servers (M-SRVs) 406 that are coupled to one or more of packet-based networks 402. Servers 406 produce multimedia streams containing content such as audio, video, and/or text. For example, a particular server 406 may provide multiple audio streams via multiple audio channels. In addition, this server may provide text streams that are synchronized with corresponding audio streams.

In addition to M-SRVs 406, the environment of FIG. 4 includes a plurality of file streaming servers (F-SRVs) 408. These servers produce file streams in the form of file carousels. A file carousel typically contains several files that are transmitted using, for example, IP multicast. These files are transmitted one at a time at controlled bit rates until all files have been transmitted. At this point the file carousel repeats the transmission of the files. This pattern may go on either continuously or for fixed intervals of time.

Each of servers 406 and 408 may distribute their streams to one or more destinations across packet-based networks 402. Such distribution may involve IP multicasting protocols, such as ALC. The combined bit rate of all streams produced by a particular server typically varies over time. In embodiments, these variations are around a stable average.

FIG. 4 shows multiple IP encapsulators (IPEs) 410 that are each coupled to one or more of packet-based networks 402. IPEs 410 receive packet streams produced by servers 406 and 408 and operate as gateways between packet-based networks 402 and broadcast networks 404. In particular, IPEs 410 convert received packet streams into broadcast network transport streams (e.g., DVB-H transport streams, and DVB-T transport streams).

For each broadcast network 404, FIG. 4 shows a multiplexer (MUX) 412, a modulator (MOD) 414, and a transmitter (TX) 416. In particular, FIG. 4 shows a MUX 412a, a MOD 414a, and a TX 416a corresponding to broadcast network 404a, a MUX 412b, a MOD 414b, and a TX 416b corresponding to broadcast network 404b, and a MUX 412c, a MOD 414c, and a TX 416c corresponding to broadcast network 404c. As shown in FIG. 4, each MUX 412 may be coupled to one or more IPEs 410. Also, each MOD 414 is coupled between its corresponding MUX 412 and TX 416.

Each multiplexer 412 combines transport streams from one or more different sources (such as different IPEs 410) into a single transmission stream. This transmission stream may be in the form of burst transmissions. These bursts may be transmitted during a corresponding portion (or time slice) of successive time slots.

FIG. 4 shows that the single stream is sent to the coupled modulator 414, which converts the transmission stream from a digital representation into a radio frequency (RF) signal. The coupled transmitter (TX) 416 amplifies the RF signal and transmits it (or broadcasts) the signal to the devices in the corresponding broadcast network 404. For broadcast networks 404a and 404b, antennas 417a and 417b allow such transmissions to propagate wirelessly. However, for broadcast network 404c, such transmissions propagate through a cable medium 419.

FIG. 4 shows that broadcast networks 404 include one or more receivers (RXs) 420, which are also referred to herein as terminal devices. These devices receive and process RF signals transmitted by TXs 416. This allows the devices to present the services (e.g., streams) conveyed by the RF signals to its end-users. As shown in FIG. 4, devices 420 may include portable handheld devices (such as wireless telephones and PDAs), as well as televisions, set-top boxes, and personal computers.

In addition, broadcast networks 404 may include other devices, such as repeaters and monitors (not shown). A repeater (REP) receives an RF signal from a TX 416, amplifies it, and transmits it again, either on the same frequency or a different frequency. A monitor (MON) is a special receiver having the sole purpose of monitoring RF signals received from a transmitter 416 and providing alarms to the operator of the corresponding broadcast network 404.

V. PACKET SEQUENCES

As described above, errors often occur on radio broadcast links. Such errors may be attributed to device portability. For instance, a service (such as a television program) may be interrupted when a device moves into a location where bursts cannot be received. Errors may occur for other reasons as well, such as interference caused by other transmissions. Such errors may cause some receiving devices to miss the end of session packet. Moreover, DVB-H links, devices may even lose an entire time slice burst. However, in the face of such errors, the present invention provides for session transport mechanisms that reliably inform devices of session terminations.

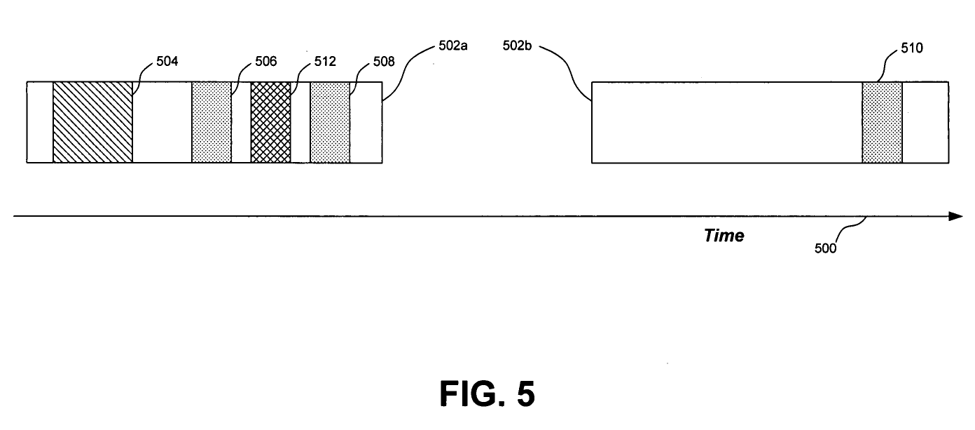

FIG. 5 is a diagram of an exemplary packet transmission sequence along a time axis 500, according to aspects of the present invention. For purposes of illustration, this sequence is described with reference to a time slicing environment, such as the environment of FIG. 4. Accordingly, this sequence includes a time slice burst 502a that conveys multiple packets. For instance, FIG. 5 shows burst 502a conveying a session data packet 504. Packet 504 is the last data packet of its session. Therefore, burst 502a also includes EOS packets 506 and 508. These packets signal that the session to which data packet 504 relates is terminated. EOS packet 506 may carry data relating to the transport object or to the session in addition to the EOS flag or it carries only the EOS flag.

In embodiments of the present invention, the originator of the session corresponding to data packet 504 may also send an EOS packet in a subsequent time period. Accordingly, FIG. 5 shows a subsequent burst 502b, which includes an EOS packet 510. Thus, in the example of FIG. 5, devices are informed of a session termination through packets 506, 508, and 510. Similarly, time slice burst 502a includes an EOS packet 512. This packet signals the end of a different session that terminated during a previous time slice (not shown).

Thus, in embodiments of the present invention, more than one packet carrying an EOS flag (i.e., an EOS packet) may be transmitted in a single burst.

VI. SESSION PROVIDER

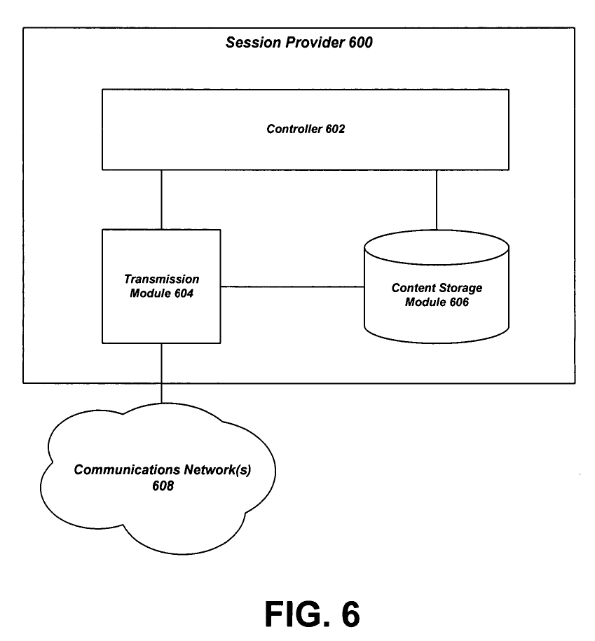

FIG. 6 is a diagram of a session provider apparatus 600 that may perform the techniques of the present invention. As shown in FIG. 6, apparatus 600 includes a controller 602, a transmission module 604, and a content storage module 606.

Controller 602 establishes a transport session in which objects may be sent to one or more remote devices. Accordingly, controller 602 may interact with transmission module 604 and storage module 606 to establish various session parameters.

As shown in FIG. 6, transmission module 604 provides an interface with one or more communications networks 608. Accordingly, transmission module 604 sends a plurality of data packets of the transport session to one or more devices. In addition, when sending a final data packet of a transport session, transmission module 604 also sends an EOS packet for the transport session within the same time period as the final data packet. As described above, this time period may be a time slice in a broadcast network. However, the use of other time periods are within the scope of the present invention. To increase the probability that remote devices are become aware of a session termination, transmission module 604 may also send further EOS packet(s) in subsequent time period(s) (such as one or more time slices).

Content storage module 606 includes a storage medium that stores content items that may be delivered as objects in transport sessions. As described above, such content items may include files, video, audio, multimedia, etc.

Apparatus 600 may be implemented as a server (such as servers 102, 406, and 408). Also, apparatus may be implemented at the “head-end” of a broadcast network. Accordingly, apparatus 600 may be implemented in, for example, an encapsulator such as an IPE 410. Moreover, in embodiments, apparatus 600 may be implemented by two or more devices, such as a remote server (e.g., servers 406 and 408) operating in conjunction with a broadcast network “head-end” to ensure that final data packets and EOS packets are sent in the appropriate time frames. This operation may occur through signaling, rules, and/or other communications between such devices.

VII. COMPUTER SYSTEM

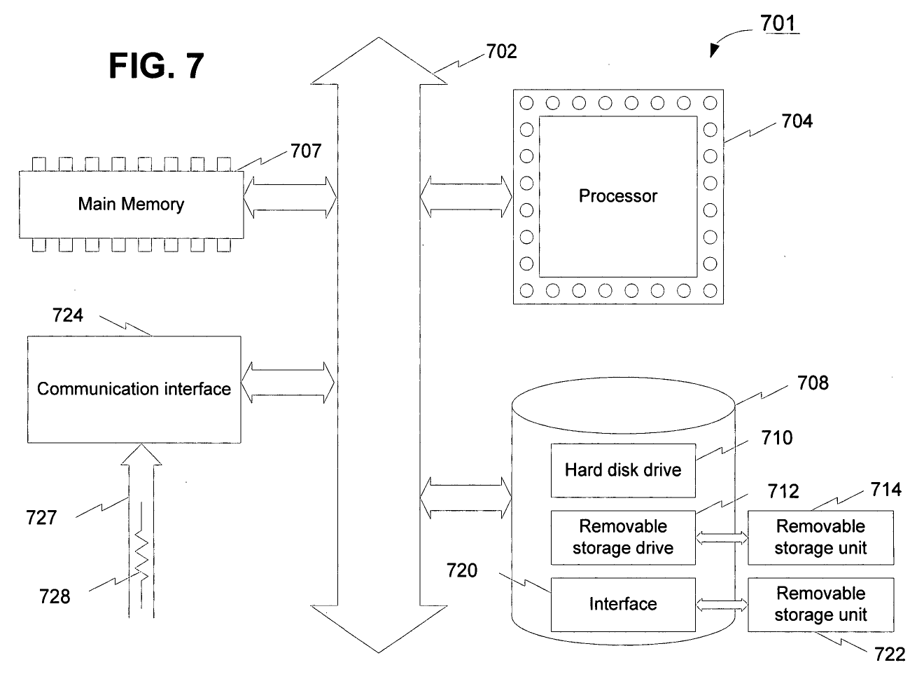

Devices, such as servers 102, 406, and 408, may be implemented with one or more computer systems. An example of a computer system 701 is shown in FIG. 7. Computer system 701 represents any single or multi-processor computer. Single-threaded and multi-threaded computers can be used. Unified or distributed memory systems can be used.

Computer system 701 includes one or more processors, such as processor 704. One or more processors 704 can execute software implementing techniques of the present invention. Each processor 704 is connected to a communication infrastructure 702 (for example, a communications bus, cross-bar, or network). Various software embodiments are described in terms of this exemplary computer system. After reading this description, it will become apparent to a person skilled in the relevant art how to implement the invention using other computer systems and/or computer architectures.

Computer system 701 also includes a main memory 707 which is preferably random access memory (RAM). Computer system 701 may also include a secondary memory 708. Secondary memory 708 may include, for example, a hard disk drive 710 and/or a removable storage drive 712, representing a floppy disk drive, a magnetic tape drive, an optical disk drive, etc. Removable storage drive 712 reads from and/or writes to a removable storage unit 714 in a well known manner. Removable storage unit 714 represents a floppy disk, magnetic tape, optical disk, etc., which is read by and written to by removable storage drive 712. As will be appreciated, the removable storage unit 714 includes a computer usable storage medium having stored therein computer software and/or data.

In alternative embodiments, secondary memory 708 may include other similar means for allowing computer programs or other instructions to be loaded into computer system 701. Such means can include, for example, a removable storage unit 722 and an interface 720. Examples can include a program cartridge and cartridge interface (such as that found in video game devices), a removable memory chip (such as an PROM, EPROM, EEPROM, flash memory, etc.) and associated socket, and other removable storage units 722 and interfaces 720 which allow software and data to be transferred from the removable storage unit 722 to computer system 701.

Computer system 701 may also include one or more communications interfaces 724. Communications interfaces 724 allow software and data to be transferred between computer system 701 and external devices via communications path 727. Examples of a communications interface 724 include a modem, a network interface (such as an Ethernet card), a communications port, etc. Software and data transferred via communications interfaces 724 are in the form of signals 728 which can be electronic, electromagnetic, optical or other signals capable of being received by communications interfaces 724, via communications paths 727. Note that communications interfaces 724 provide a means by which computer system 701 can interface to a network such as the Internet.

The present invention can be implemented using software running (that is, executing) in an environment similar to that described above with respect to FIG. 7. In this document, the term “computer program product” is used to generally refer to removable storage units 714 and 722, a hard disk installed in hard disk drive 710, or a signal carrying software over a communication path 727 (wireless link or cable) to communication interfaces 724. A computer useable medium can include magnetic media, optical media, or other recordable media, or media that transmits a carrier wave or other signal. These computer program products are means for providing software to computer system 701.

Computer programs (also called computer control logic) are stored in main memory 707 and/or secondary memory 708. Computer programs can also be received via communications interfaces 724. Such computer programs, when executed, enable the computer system 701 to perform the features of the present invention as discussed herein. In particular, the computer programs, when executed, enable the processor 704 to perform the features of the present invention. Accordingly, such computer programs represent controllers of the computer system 701.

The present invention can be implemented as control logic in software, firmware, hardware or any combination thereof. In an embodiment where the invention is implemented using software, the software may be stored in a computer program product and loaded into computer system 701 using removable storage drive 712, hard drive 710, or interface 720. Alternatively, the computer program product may be downloaded to computer system 701 over communications paths 727. The control logic (software), when executed by the one or more processors 704, causes the processor(s) 704 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

VIII. Conclusion

While various embodiments of the present invention have been described above, it should be understood that they have been presented by way of example only, and not in limitation. For instance, although examples have been described involving DVB-T, DVB-H, and cable technologies, other technologies are within the scope of the present invention. Also, transport mechanisms other than ALC are within the scope of the present invention.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method, comprising:
transmitting across a transmission medium a final data packet of a transport session within a time period; and
transmitting across the transmission medium an end of session (EOS) packet corresponding to the transport session within the time period, the EOS packet having an end of session indicator.

2. The method of claim 1, further comprising:
transmitting a further EOS packet corresponding to the transport session within a subsequent time period.

3. The method of claim 1, wherein the final data packet and the EOS packet each have a session identifier identifying the transport session.

4. The method of claim 1, wherein the transport session is an Asynchronous Layered Coding (ALC) session.

5. The method of claim 2, wherein the transmission medium is a broadcast medium, and wherein the time period is a first time slice and the subsequent time period is a second time slice occurring after the first time slice.

6. The method of claim 5, wherein the broadcast transmission medium is a digital broadband broadcast network.

7. The method of claim 6, wherein the digital broadband broadcast network is a DVB handheld (DVB-H) network.

8. The method of claim 6, wherein the digital broadband broadcast network is a DVB terrestrial (DVB-T) network.

9. The method of claim 5, wherein the broadcast transmission medium is a cable network.

10. An apparatus, comprising:
a controller configured to establish a transport session; and
a transmission module configured to send a plurality of data packets of the transport session to one or more devices;
wherein the transmission module is further configured to transmit a final data packet of the transport session within a time period, and to transmit an end of session (EOS) packet corresponding to the transport session within the time period, the EOS packet having an end of session indicator.

11. The apparatus of claim 10, wherein the transmission module is further configured to transmit a further EOS packet corresponding to the transport session within a subsequent time period.

12. The apparatus of claim 10, wherein the plurality of data packets convey a content item; and
wherein the apparatus further includes a storage medium configured to store the content item.

13. The apparatus of claim 10, wherein the final data packet and the EOS packet each have a session identifier identifying the transport session.

14. The apparatus of claim 10, wherein the transport session is an Asynchronous Layered Coding (ALC) session.

15. The apparatus of claim 10, wherein the final data packet and the EOS packet each have a session identifier identifying the transport session.

16. The apparatus of claim 11, wherein the time period is a first time slice of a broadcast medium and the subsequent time period is a second time slice of the broadcast medium, wherein the second time slice occurs after the first time slice.

17. A computer program product comprising a computer useable medium having computer program logic recorded thereon for enabling a processor in a computer system, the computer program logic comprising:
program code for enabling the processor to transmit across a transmission medium a final data packet of a transport session within a time period; and
program code for enabling the processor to transmit across the transmission medium an end of session (EOS) packet corresponding to the transport session within the time period, the EOS packet having an end of session indicator.

18. The computer program product of claim 17, further comprising:
transmitting a further EOS packet corresponding to the transport session within a subsequent time period.

19. The computer program product of claim 17, wherein the final data packet and the EOS packet each have a session identifier identifying the transport session.

20. The computer program product of claim 17, wherein the transport session is an Asynchronous Layered Coding (ALC) session.
